(19) United States
(12) Patent Application Publication
(10) Pub. No.: US 2026/0340189 A1
(43) Pub. Date: Oct. 29, 2026

(54) SYSTEM AND METHOD FOR HARDWARE-BASED ANONYMIZATION OF NETWORK ADDRESSES

(71) Applicant: VP Net LLC, Broomfield, CO (US)

(72) Inventor: Andrew Lee, Thousand Oaks, CA (US)

(21) Appl. No.: 19/658,193

(22) Filed: Apr. 24, 2026

Related U.S. Application Data
(60) Provisional application No. 63/794,685, filed on Apr. 25, 2025.

(51) Int. Cl. G06F 21/62; H04L 9/32; H04L 9/40

(52) U.S. Cl. CPC G06F 21/6254; H04L 9/3236; H04L 9/40

(57) ABSTRACT

This system presents a split architecture combining a host process for network handling with secure hardware enclave for isolated cryptographic operations. The enclave securely manages identity mappings, session keys, and routing information, ensuring complete separation from the untrusted host. Leveraging cryptography, embodiments enable secure key exchange, encryption, and traffic authentication. Through multi-layered identity obfuscation, request mixing, and traffic padding, the system defends against traffic analysis and correlation attacks. Remote attestation provides stronger integrity of the enclave, ensuring clients communicate with verified, uncompromised code. Additionally, the system supports advanced traffic shaping and dummy traffic generation, disguising communications within common network protocols. Upon session termination, ephemeral keys and routing data are purged, leaving no persistent records. Accordingly, embodiments of the present disclosure provide robust anonymity, cryptographic integrity, and traffic confidentiality, suitable for high-security communication environments, such as in a privacy focused networking environment.

### CROSS-REFERENCE TO RELATED APPLICATIONS

This application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)). In addition, the present application is related to the “Related Applications,” if any, listed below.

### STATEMENT REGARDING FEDERALLY SPONSORED RESEARCH AND DEVELOPMENT

Not Applicable.

### PRIORITY APPLICATIONS

U.S. Provisional Patent Application App. No. U.S. 63/794,685 titled “System and Method for Hardware-Based Anonymization of Network Addresses” filed on Apr. 25, 2025, the subject matter of which is incorporated by reference herein in its entirety.

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

If an Application Data Sheet (ADS) has been filed on the filing date of this application, it is incorporated by reference herein. Any applications claimed on the ADS for priority under 35 U.S.C. § 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### FIELD OF INVENTION

The present disclosure relates to network privacy and security technologies, and more particularly to a system and method for anonymizing or disassociating user identities from network traffic.

### BACKGROUND OF DISCLOSURE

A Virtual Private Network (VPN) is a service that establishes a secure, encrypted connection between a user's device and the internet. This connection routes the user's online traffic through a remote server operated by the VPN provider, masking the user's IP address and location, and safeguarding the data from interception or surveillance. VPNs are commonly used to protect privacy, enhance security on public or untrusted networks, and bypass geographic restrictions by making it appear as though the user is accessing the internet from a different location.

A VPN provider offers a service that creates a secure, encrypted connection between a user's device and the internet. This connection, often called a VPN tunnel, routes the user's internet traffic through a server operated by the VPN provider, masking the user's IP address and location, and encrypting data transmissions to enhance privacy and security. VPNs are commonly used to protect sensitive data on public Wi-Fi networks, bypass geographic restrictions, and prevent third parties, such as ISPs, advertisers, or governments, from tracking online activity.

While many VPN providers advertise “no-logs” and “no data sharing” policies, these claims offer no absolute guarantee that user data is fully protected. Most of these statements are self-reported by the providers themselves, and unless verified through independent audits, cannot be confirmed as accurate over time. Without real-time oversight, users have no way of ensuring that these providers consistently uphold their privacy commitments. Conventional Virtual Private Networking (VPNs) services typically rely on policy-based assurances that user identities or activities will not be logged or correlated. These assurances, however, are vulnerable to: unauthorized access or misuse by privileged administrators, who may be able to view, log, or correlate user identities to their browsing activities; compromise of the VPN server or the underlying infrastructure, allowing attackers to extract logs or memory data and correlate connections; weak cryptographic implementations that may leak metadata or allow timing attacks, thus enabling third parties to correlate traffic patterns.

Privacy policies themselves may be misleading and often contain ambiguous language, allowing providers to collect certain types of metadata, such as connection timestamps, bandwidth usage, or device information. Although this may be labeled as “anonymized” or collected for “service improvement,” such data can still be sold to advertisers or shared with third parties, undermining user privacy.

Furthermore, history has shown that several VPN services have been caught logging or misusing user data despite their no-logs claims. Notable examples of VPN providers that were exposed for data practices inconsistent with their public statements are known. This risk is particularly high with free VPN services, which often rely on data monetization, advertising, or trackers as revenue sources, since they do not generate income from subscriptions.

Ultimately, while no-logs and no data sharing claims sound reassuring, they do not provide an ironclad guarantee of privacy. Some providers have made stronger assurances that they undergo regular independent audits, maintain transparent ownership structures, and operate in privacy-friendly jurisdictions. However, even so, some level of trust is required when using any VPN service.

Accordingly, there is a need for solutions that provide stronger assurances, protections and cryptographic separation.

### SUMMARY OF THE INVENTION

The present invention provides a system and method for hardware-enforced anonymization of network traffic.

In an embodiment, the method comprises: receiving, by a host process, network requests that are encrypted from one or more client devices; forwarding, by the host process, the network requests to a secure enclave; mapping, within the secure enclave, each client identity to a temporary session identifier using cryptographic operations; mapping, within the secure enclave, each temporary session identifier to an ephemeral routing identifier; mixing, within the secure enclave, destination requests from other clients into batched output traffic; and forwarding, by the host process, packets of the batched output traffic to external network destinations, such that a source identity of each packet of the batched output traffic remains unlinkable to the external network destinations.

In an embodiment, the secure enclave comprises a hardware-isolated memory region that is encrypted at a central processor level, preventing unauthorized access by operating system or administrative processes.

In an embodiment, the method further comprises verifying enclave integrity via a remote attestation, wherein the remote attestation guarantees that the secure enclave is genuine, unmodified, executing and secure.

In an embodiment, code of the secure enclave is compiled using a deterministic build process that produces a reproducible enclave measurement hash from a given set of source code, and wherein verifying the enclave integrity further comprises: publishing the given set of source code of the secure enclave as a published source code; a client device independently compiling the published source code using the deterministic build process to produce a locally-computed enclave measurement hash; retrieving, by the client device, an enclave measurement hash from the remote attestation as a retrieved enclave measurement hash; and comparing the locally-computed enclave measurement hash with the retrieved enclave measurement hash to verify that the secure enclave is executing the published source code without modification.

In an embodiment, the host process maintains a plurality of concurrent communication channels with the secure enclave, and wherein mixing the destination requests from multiple the other clients further comprises: receiving, by the secure enclave, an encrypted network request from a first client device via a first communication channel of the plurality of concurrent communication channels; processing the encrypted network request within the secure enclave to produce a decrypted outbound packet; and transmitting the decrypted outbound packet from the secure enclave to the host process via a second communication channel of the plurality of concurrent communication channels, the second communication channel being selected by a deterministic rotation across the plurality of concurrent communication channels, such that the host process cannot correlate the encrypted network request received on the first communication channel with the decrypted outbound packet transmitted on the second communication channel.

In an embodiment, the cryptographic operations in the secure enclave include at least one of encryption, authentication, key exchange, hashing, and identity blinding functions.

In an embodiment, the traffic mixing comprises batching, padding, dummy traffic generation, and traffic shaping to prevent timing correlation and packet-size analysis.

In an embodiment, the method comprises receiving, within a secure enclave, a decrypted network packet originating from a first client device of a plurality of client devices, the decrypted network packet bearing a source address that identifies the first client device; mapping, by performing network address translation within the secure enclave by replacing the source address of the decrypted network packet with a shared masquerade address and assigning an ephemeral port number, and recording the mapping in a connection-tracking table stored in encrypted memory of the secure enclave, to produce a translated network packet; forwarding the translated network packet from the secure enclave to a host process for transmission to an external network destination having a destination address, the host process receiving only the shared masquerade address as a source address of the translated network packet; and upon receiving a return packet addressed to the shared masquerade address and the ephemeral port number, translating, within the secure enclave, the destination address back to the source address of the decrypted network packet using the connection-tracking table, wherein the host process has no access to the connection-tracking table and cannot determine which of the plurality of client devices originated any given outbound packet.

In an embodiment, the system comprises: a host process managing encrypted network traffic with no access to correlation between user identities and network destinations; and a secure enclave that is hardware isolated and configured to execute cryptographic mapping from the user identities to ephemeral route identifiers, and perform traffic mixing and anonymization.

In an embodiment, the secure enclave further comprises a network address translation engine executing entirely within a memory region that is hardware-isolated and encrypted, the network address translation engine configured to: maintain, within the secure enclave, connection-tracking tables that map each of a plurality of originating client device's network addresses of the plurality of client devices and port each of the plurality of network addresses to a shared masquerade address and an ephemeral port number selected by the secure enclave, the ephemeral port number corresponding to the shared masquerade address; rewrite a source address of each outbound packet corresponding to each originating client device's network address to the shared masquerade address and the ephemeral port number, such that all outbound packets forwarded by the host process bear only the shared masquerade address as their source; for each inbound return packet received by the host process, forward the corresponding inbound return packet to the secure enclave, which translates the shared masquerade address and the ephemeral port number back to the corresponding originating client device's network address using the connection-tracking tables; and discard expired connection-tracking entries based on per-protocol timeouts, wherein the connection-tracking tables and all address-mapping state reside exclusively within the memory region of the secure enclave, and no process outside the secure enclave has access to any mapping between any client device's address and the shared masquerade address.

In an embodiment, they system further comprises a remote attestation process, enabling each of a plurality of client devices to verify that the secure enclave is unmodified and operating within genuine hardware protections; the secure enclave is compiled using a deterministic build process such that identical source code produces an identical enclave measurement hash; and wherein the remote attestation process further enables a client device of the plurality of client devices to independently compile the identical source code of the secure enclave, derive a locally-computed enclave measurement hash, and compare the locally-computed enclave measurement hash against the identical enclave measurement hash reported in the remote attestation process, thereby verifying that the secure enclave is executing an exact published source code.

In an embodiment, the system further comprises a plurality of concurrent inter-process communication channels between the host process and the secure enclave, wherein the secure enclave is configured to: receive inbound encrypted packets from the plurality of client devices via the plurality of communication channels; after decrypting and processing each of the inbound encrypted packets within the secure enclave into a processed packet, select an outbound communication channel as a selected outbound communication channel from the plurality of communication channels using a rotating index that is independent of a communication channel of the plurality of communication channels on which a corresponding inbound encrypted packet of the inbound encrypted packets was received; transmit the processed packet to the host process via the selected outbound communication channel; and whereby the host process observes the inbound encrypted packets and outbound processed packets distributed across the plurality of communication channels without ability to correlate which inbound packet on a given channel corresponds to which outbound packet on another channel.

In an embodiment, the secure enclave is configured to store all identity-related mappings, ephemeral keys, and route identifiers in encrypted memory, inaccessible to any process outside the secure enclave.

In an embodiment, the secure enclave executes one or more cryptographic functions.

In an embodiment, no logs or records associating any of the user identities with destination addresses of the network destinations are stored outside the secure enclave, ensuring physical unavailability of correlation data.

In an embodiment, the system further comprises a traffic obfuscation mechanism that injects dummy packets and padding to obscure real traffic patterns from observers.

The embodiments described herein provide robust anonymity, cryptographic integrity, and traffic confidentiality, suitable for high-security communication environments, such as in a privacy focused networking environment.

### BRIEF DESCRIPTION OF DRAWINGS

Examples according to the present disclosure will now be described, by way of example, with reference to the attached Figures.

FIG. 1 is a high-level system architecture showing an exemplary split design between a host process and a secure enclave.

FIG. 2 is an illustration of a server system having exemplary secure enclave components, including the Protocol Core, Identity Vault, and Traffic Processor that may be implemented according to one or more embodiments of the present disclosure.

FIG. 3 is an exemplary data flow diagram of the cryptographic anonymization process, highlighting user-to-session and session-to-route ID mappings according to one or more embodiments of the present disclosure.

FIG. 4 is an exemplary flow of key exchanges and secure enclave operations during the handshake and ongoing data transfers according to one or more embodiments of the present disclosure.

The following detailed description references the above figures and representative embodiments, with the understanding that any variations or modifications that do not depart from the inventive concepts are considered within the scope of this disclosure.

### DETAILED DESCRIPTION

The following description elaborates on the system architecture and components, providing a comprehensive technical overview. It includes reference to specific embodiments, with the understanding that any variations or alternative implementations that do not deviate from the principles of the embodiments should be considered to be within the scope of this disclosure.

In one aspect, embodiments of the present disclosure improve VPN trust and security by attempting to make it physically impossible to correlate user identity information with destination addresses. The present embodiments accomplish this, for example, by employing hardware-isolated enclaves, cryptographic blinding, and traffic mixing techniques to ensure that user identities cannot be linked to outbound traffic.

For example, by leveraging hardware-enforced isolation (such as using Intel® Software Guard Extensions (SGX) enclaves) and cryptographic mechanisms to ensure that user identities cannot be correlated with their destinations, in one aspect, the present disclosure provides a hardware-enforced anonymization system server that employs a split architecture separating user identity management from packet routing via secure hardware-isolated environment.

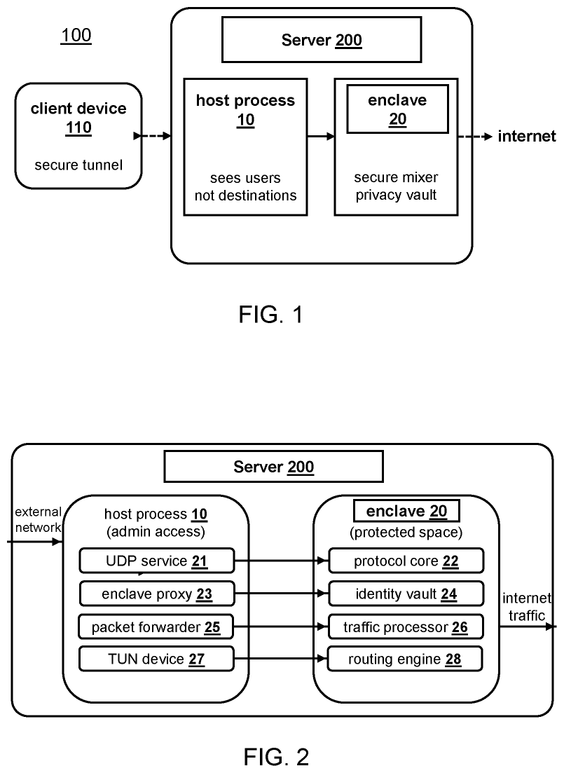

FIG. 1 is a high-level system architecture 100 showing an exemplary split design between a host process 10 and a secure enclave 20. As shown in FIG. 1, the system architecture 100 features a split design, separating core cryptographic operations from network handling. At the operating system level, the host process 10 manages network connectivity and forwards encrypted traffic without any visibility into cryptographic mappings. In one embodiment, these identity-related mappings, which may also be referred to as connection-tracking tables and address-mapping state, are securely maintained and stored within a SGX enclave, that is, a hardware-protected memory region where the core cryptographic and identity functions are executed. Hence, even a root-level administrator cannot access the memory of the enclave 20 because no logs or records associating user identities with destination addresses are stored outside the secure enclave 20, ensuring physical unavailability of correlation data. Furthermore, the enclave 20 is remote-attestable, allowing clients to cryptographically verify that the server 200 is running the correct enclave code.

Regarding physical separation, a host process 10 on the server 200 handles encrypted packets 30 but lacks the cryptographic keys and correlation data required to associate users with specific destinations 40. A secure enclave 20 (such as an SGX enclave or similar secure environment) manages all sensitive operations (cryptographic identity-related mapping, key exchange, user-destination association) in encrypted memory, inaccessible to system administrators or the operating system. In one aspect, multi-layer cryptographic mapping is used where user identities are converted, translated, or rewritten into temporary session IDs, which are then mapped into ephemeral route IDs. The temporary session IDs may also be referred to as shared masquerade addresses, and the ephemeral route IDs may also be referred to as ephemeral port numbers. Outbound requests are batched and mixed from multiple users, preventing correlation via timing or packet-size analysis. That is, the host process has no access to the connection-tracking table and cannot determine which client device originated any given outbound packet.

Traffic mixing and obfuscation is used for packet padding, dummy traffic generation, and traffic shaping are employed to thwart traffic analysis and size-correlation attacks. Remote attestation of clients verifies enclave integrity and authenticity via the secure enclave, ensuring and proving that only genuine, unmodified code can claim these privacy guarantees.

By leveraging hardware-enforced isolation and careful cryptographic design, the embodiments of the present disclosure establish a privacy solution that is architecturally incapable of correlating user identities with their browsing activities, surpassing traditional policy-based VPN approaches.

In some embodiments, the system architecture 100 may employ a split design to effectively segregate cryptographic operations from general network functions, a strategy that enhances both security and compartmentalization. Operating at the level of the host operating system, the host process handles all networking-related responsibilities, such as maintaining network socket connections, managing inbound and outbound packet forwarding, and performing network I/O operations. Crucially, the host process operates in a limited trust domain and has no direct access to any cryptographic mappings or sensitive identity data. These sensitive operations can be delegated, for example, to a secure enclave such as an Intel Software Guard Extensions (SGX) enclave, which functions as a hardware-protected Trusted Execution Environment (TEE). This enclave offers strong memory isolation enforced at the CPU level, which may also be referred to as the central processor level, ensuring that even system administrators or attackers with root-level privileges cannot access the protected enclave memory. That is, the hardware-isolated memory region of the secure enclave is encrypted at a central processor level, thereby preventing unauthorized access by operating system or administrative processes. The SGX enclave is equipped with remote attestation capabilities, allowing clients to cryptographically verify that the server is executing the intended and reported enclave code or enclave measurement hash and that the enclave environment has not been tampered with. The client connects to the TEE and verifies its attestation based on rules defined by the TEE vendor. Only once the attestation has been verified will the client send its authentication token to gain access to the VPN service.

One skilled in the art will recognize that Intel SGX represents just one example of TEE technology, and various alternative or complementary secure computation frameworks may be employed depending on the deployment context and specific security requirements, all within the scope of the present disclosure. For instance, ARM TrustZone offers hardware-isolated execution environments at the system-on-chip (SoC) level, enabling secure execution alongside conventional operating systems for mobile and embedded platforms. Similarly, AMD Secure Encrypted Virtualization with Secure Nested Paging (SEV-SNP) extends hardware-based memory encryption to entire virtual machine instances, protecting against attacks from compromised hypervisors and other privileged system components. Beyond these, technologies such as RISC-V MultiZone Security, which provides compartmentalized security domains in open-source processor architectures, and IBM Power Systems Protected Execution Facility (PEF), designed for secure virtualization on enterprise servers, offer additional avenues for trusted computing. Furthermore, emerging frameworks like Google's Asylo, a software development environment for enclaves, and Microsoft's Azure Confidential Computing, which integrates secure enclave technologies into cloud infrastructure, can be implemented in various embodiments of the present disclosure for ensuring confidentiality and integrity of code and data during execution. One skilled in the art will also recognize that the present disclosure provides for multiple architectures in which the majority of the infrastructure including core logic, protocol handling, and data processing can be implemented directly within the enclave, reducing reliance on the untrusted host process to a minimal role, for example, managing I/O and syscall mediation. While some implementations may utilize significant separation between host and enclave functions, sometimes even compiling them into separate binaries, for example to accommodate certain hardware or memory limitations, such as the constrained size of the Enclave Page Cache (EPC), which restricted the amount of memory available to the enclave and required careful partitioning of workloads. However, in some embodiments, TEEs that have different EPC sizes and memory constraints may utilize more integrated enclave designs, where larger portions of the application infrastructure including stateful services, in-memory data structures, and protocol stacks can securely operate within the enclave without compromising performance or scalability. These embodiments may be implemented to enhance security by reducing the attack surface and limiting the exposure of sensitive data and logic to the untrusted host.

Referring now to FIG. 2, the server 200 implementation integrates several key functional components, each with distinct roles. The server implementation architecture shown in FIG. 2 is merely exemplary. Various services and processes may be located in either the host process or enclave based on a number of various criteria. For example, the UDP service acts as the primary interface for handling network communication via User Datagram Protocol (UDP). This service manages socket-level operations, including receiving and sending datagrams, while also incorporating anti-denial-of-service (DoS) mechanisms. Specifically, it implements a cookie-based challenge-response protocol, which mirrors the concept of SYN cookies in TCP, to validate the legitimacy of inbound traffic before allocating system resources. This measure prevents resource exhaustion attacks by requiring minimal state retention until the authenticity of incoming packets is established. For alternative transport-layer implementations, protocols such as QUIC or TCP with TLS and TCP Fast Open could be integrated. QUIC, for example in some embodiments, offers native encryption and improved connection establishment times, making it suitable for environments where UDP might face network restrictions. In another embodiment, the UDP process can operate within an enclave through a hybrid architecture. For example, in this embodiment, the untrusted host process handles the UDP socket I/O—receiving datagrams from the network and forwarding them to the enclave via secure enclave calls (ECALLs). The enclave then processes the sensitive portions of the UDP payload, such as performing encryption, decryption, authentication, or integrity validation, before returning the processed data to the host for transmission. This approach allows sensitive cryptographic operations and key management to occur securely within the enclave, while the host process manages the network-facing communication. By isolating data and computation within the enclave, the system can ensure confidentiality and integrity even in untrusted environments, such as hostile networks or compromised hosts, while maintaining performance through separation of duties.

As shown in FIG. 2, serving as the intermediary between the host process is the enclave proxy 23, a lightweight software layer responsible for facilitating controlled data exchanges. This proxy handles enclave calls (ECALLs) and outside calls (OCALLs), ensuring that only properly formatted, validated, and encrypted data is transmitted between the untrusted host and the enclave. By strictly enforcing data formatting and validation at the boundary, the proxy mitigates the risk of malformed data or potential attacks entering the secure enclave. In more complex environments, frameworks like the Open Enclave SDK or Graphene Shielded Execution Framework (SGX-LKL) could be employed to further abstract enclave communication and support a broader range of enclave-host interaction patterns.

Within the enclave itself resides the protocol core 22, a critical module responsible for implementing the cryptographic stack that enables secure communications. In some embodiments, the cryptographic stack adheres to a VPN security protocol. For example, in one embodiment, the cryptographic stack implements encryption and authentication of traffic using appropriate cryptographic algorithms. Examples may include but are not limited to WireGuard-compatible cryptographic standards, utilizing ChaCha 20 with 256-bit keys for symmetric encryption. ChaCha 20 may be chosen for its high-performance characteristics on general-purpose CPUs, particularly those lacking hardware acceleration for AES. Message authentication can be enforced using Poly1305, which ensures data integrity and authenticity. The Curve25519 elliptic curve Diffie-Hellman (ECDH) protocol facilitates secure key exchanges, establishing shared secrets between clients and the server without transmitting private keys over the network. Finally, BLAKE2s, a high-speed cryptographic hash function, is employed for hashing sensitive data within the enclave, including session identifiers and ephemeral route tokens. Alternative cryptographic primitives, such as AES-GCM for encryption or SHA-3 for hashing, could be employed in environments where hardware acceleration (e.g., AES-NI) is available or when compliance requirements dictate specific algorithms. One skilled in the art will recognize that the cryptographic stack may implement other standards. For example, the cryptographic standards may also be compatible with other TUN devices. The architecture of the present disclosure may utilize protocols, such as OpenVPN, IPSec, which can be paired with the IKEv2 key exchange protocol, L2TP/IPSec, SoftEther VPN, SSL/TLS-based VPNs, etc.

The identity vault is another enclave-resident component responsible for securely managing user identity data, including cryptographic public keys. This vault ensures that no sensitive identity information is exposed to the host process, enforcing strict isolation. It also manages the generation of ephemeral session identifiers (IDs), which act as anonymized representations of user identities throughout a session. Instead of directly exposing persistent identifiers, these session IDs are generated using cryptographically secure methods, preserving user privacy and unlinkability of a source identity of each request with the external network destinations. The source identity of each request may also be referred to as a decrypted network packet originating from a client device 110 and bearing a source address that identifies the client device 110, and may also be referred to as the originating client device's network address.

Handling network obfuscation, the traffic processor 26 performs various tasks for aggregating, mixing, and anonymizing user requests from, for example, a packet forwarder 25 while injecting dummy traffic, applying packet padding, and removing identifiable metadata that could otherwise reveal communication patterns susceptible to both conventional and machine learning-based traffic analysis. The traffic processor 26 may be designed to ensure that all outbound traffic remains statistically indistinguishable from randomized noise, mitigating risks from timing attacks, correlation analysis, and increasingly sophisticated artificial intelligence (AI) driven traffic classifiers that can infer user behaviors or protocols from subtle patterns. In more complex deployment environments, the traffic processor 26 may incorporate advanced traffic obfuscation mechanisms, such as integrating pluggable transports like Obfs4, Meek, or Snowflake, which may disguise traffic signatures to evade censorship and detection, including AI-driven detection. Additionally, techniques such as adaptive traffic shaping and adversarial perturbation methods can be deployed in some embodiments to confuse or mislead AI-based models trained for traffic fingerprinting, while dynamically modulating traffic flows based on real-time threat intelligence helps maintain resilience against evolving traffic analysis strategies, whether human or AI-driven. These layered defenses ensure robust protection against both traditional surveillance or AI-enhanced traffic inspection and censorship mechanisms.

The routing engine 28, also within the enclave 20, may receive packets from a TUN device 27 of the host process 10, and is responsible for converting ephemeral route IDs into real-world network destinations. This function further reinforces the separation of user identities from their final communication endpoints, preserving anonymity throughout the network path. For complex routing environments, the routing engine 28 could be augmented with software-defined networking (SDN) controllers, such as OpenFlow, enabling dynamic and policy-driven routing adjustments, or incorporate onion routing strategies, allowing multi-hop anonymization.

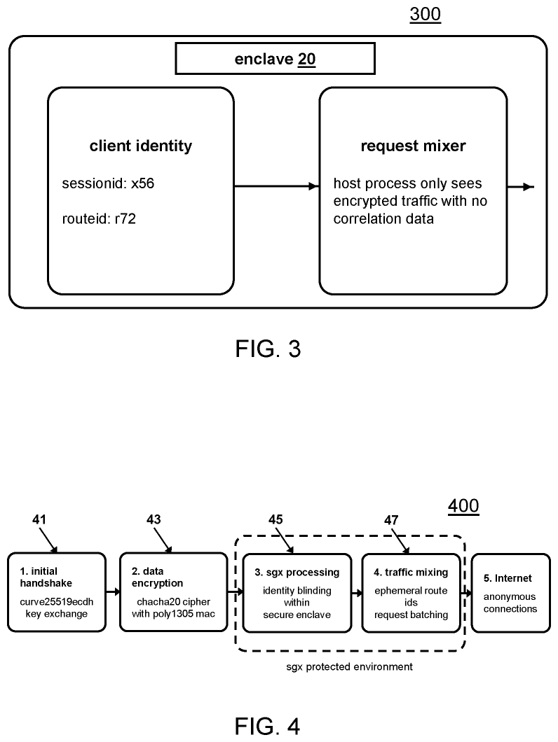

FIG. 3 is an exemplary data flow diagram 300 of the cryptographic anonymization process, highlighting user-to-session and session-to-route ID mappings according to one or more embodiments of the present disclosure. As illustrated, in one embodiment, the system's approach to identity-traffic separation is built upon three cryptographically distinct layers.

The first layer maps persistent user identities or public keys to short-lived session IDs using one-way cryptographic transformations, such as hash-based derivations with keyed functions (e.g., HMAC-BLAKE2s). This mapping ensures that persistent identity data remains confined within the enclave. The second layer involves translating session IDs into ephemeral route IDs, which are used exclusively for internal routing within the system. These route IDs are governed by strict expiration policies, typically enforced through a time-to-live mechanism, ensuring that no long-term linkability is possible. The final layer involves batching and mixing requests from multiple users, reordering the packets, and outputting them as aggregated traffic flows. A rotating index distributes outgoing packets across channels, whereby the outbound communication channel is selected by a deterministic rotation across the concurrent communication channels. This process thwarts correlation attacks based on packet timing or ordering. That is, the host process is without the ability to correlate which inbound packet on a given concurrent inter-process communication channel corresponds to which outbound packet on another concurrent inter-process communication channel. In more advanced systems, Poisson mixing algorithms or Timed Dynamic Mixers could be employed to optimize batch intervals and mixing strategies, balancing latency and anonymity guarantees. From a cryptographic design perspective, in one embodiment, the protocol stack employs at least one of ChaCha20-Poly1305, Curve25519, and BLAKE2s, all selected for their high efficiency and robust security properties across diverse hardware platforms. However, in environments that support hardware acceleration, AES-GCM may offer comparable or superior throughput due to dedicated cryptographic instruction sets like AES-NI. Similarly, post-quantum cryptographic primitives, such as Kyber for key encapsulation or Dilithium for digital signatures, could be integrated to future-proof the system against quantum computing threats.

Traffic obfuscation can be provided as a feature of embodiments of the present disclosure. Outbound packets can be padded in configurable increments, such as 16-byte blocks, to obscure the true length of transmitted content and mitigate size-based correlation attacks. Additionally, the system may inject dummy traffic at randomized or periodic intervals, with payload sizes ranging from 64 to 1024 bytes, further disguising real usage patterns. This noise generation masks user behavior and prevents traffic pattern fingerprinting. To enhance protocol camouflage, the system can shape its traffic to mimic common protocols such as HTTPS, QUIC, or WebRTC, making it difficult for network observers to distinguish between legitimate encrypted traffic and the system's obfuscated communications. Traffic obfuscation can be implemented in various embodiments of the present disclosure, designed to counter both traditional and AI-enhanced traffic analysis techniques. For example, outbound packets may be padded in configurable increments, such as 16-byte blocks or dynamically adjusted intervals, to obscure the true payload length and mitigate size-based correlation or classification attacks. Beyond simple padding, the system can inject dummy traffic at randomized or adaptive intervals, with payload sizes ranging from 64 to 1024 bytes or more, in patterns engineered to disrupt machine learning models trained to recognize statistical anomalies or usage patterns. This artificial noise generation not only masks user behavior but also introduces entropy that degrades the accuracy of AI-driven traffic fingerprinting systems. To further strengthen protocol camouflage, in some embodiments of the present disclosure, the system can dynamically shape and modulate its traffic to emulate widely used protocols such as HTTPS, QUIC, DNS-over-HTTPS (DoH), or WebRTC, ensuring that the obfuscated communications blend seamlessly with legitimate encrypted traffic. Additionally, the system may employ adaptive learning mechanisms to detect when traffic analysis algorithms, such as those using artificial intelligence models and techniques, attempt to model or classify its behavior, enabling real-time adjustments in obfuscation strategies, including protocol morphing, adversarial traffic patterns, or time-based jitter techniques. By continuously varying these parameters in response to observed network conditions and threat intelligence, the system can provide resilience even against sophisticated, AI-assisted detection methods, maintaining a high degree of plausible deniability and resistance to traffic-based surveillance.

Verification and attestation processes ensure the ongoing integrity and trustworthiness of the enclave. When a client device 110 initiates a connection, it retrieves the attestation quote from the enclave, which contains cryptographic measurements—hashes of the loaded code and data. These measurements may be validated via Intel's Attestation Service (IAS), confirming the enclave's authenticity and ensuring it operates on genuine SGX hardware. This process, which may also be referred to as a deterministic build process, can be repeated periodically or at key session junctures to detect any potential compromise or code replacement. That is, the process produces a reproducible enclave measurement hash from a given set of source code, publishes the given set of source code as a published source code. Thereafter, a client device 110 independently compiling the published source code using the deterministic build process to produce a locally-computed enclave measurement hash may retrieve an enclave measurement hash from the remote attestation as a retrieved enclave measurement hash and compare the locally-computed enclave measurement with the retrieved enclave measurement hash to verify that the secure enclave is executing the published source code exactly and without modification. For non-SGX environments, similar verification could be performed using TPM-based attestation or alternative enclave attestation frameworks such as those provided by Open Enclave SDK or Google Asylo.

FIG. 4 is an exemplary cyptographic data flow diagram 400 showing flow of key exchanges and secure enclave operations during the handshake and ongoing data transfers, according to one or more embodiments of the present disclosure. As shown, an operational flow begins with an initial handshake 41 where the client initiates, for example, a WireGuard key exchange, utilizing Curve25519 for ephemeral public key generation. During this handshake 41, the client also retrieves the enclave's attestation quote and verifies its integrity through Intel's remote attestation service. Upon successful verification, the system establishes a data encryption 43, or an encrypted communication tunnel, e.g., using ChaCha20-Poly1305. SGX Processing 45 and traffic mixing 47 within the enclave 20 ensures the client's persistent identity is securely mapped to a session ID.

User requests can be aggregated across multiple sessions, with ephemeral route IDs assigned to each request batch, ensuring that the host process only sees encrypted packets devoid of identifiable user data. Outbound traffic is routed via the enclave's routing engine, which decrypts the route IDs and forwards the packets to their intended network destinations. Return traffic follows the same anonymized path, re-mixed and re-batched for additional obfuscation. That is, upon receiving a return packet addressed to the shared masquerade address and the ephemeral port number, the destination address is translated in the secure enclave back to the source address of the decrypted network packet using the connection-tracking table. Upon session termination, all ephemeral cryptographic material, including keys and route IDs such as expired connection-tracking entries based on per-protocol timeouts, are securely discarded. Accordingly, the host environment retains no logs or persistent records, ensuring comprehensive anonymity for all user interactions.

In the preceding description, for purposes of explanation, numerous details are set forth in order to provide a thorough understanding of the examples. However, it will be apparent to one skilled in the art that these specific details are not required. Accordingly, what has been described is merely illustrative of the application of the described examples and numerous modifications and variations are possible in light of the above teachings.

Since the above description provides examples, it will be appreciated that modifications and variations can be effected to the particular examples by those of skill in the art. Accordingly, the scope of the claims should not be limited by the particular examples set forth herein, but should be construed in a manner consistent with the specification as a whole.

What is claimed is:

1. A method for hardware-enforced anonymization of network traffic, the method comprising: receiving, by a host process, network requests that are encrypted from one or more client devices;
forwarding, by the host process, the network requests to a secure enclave;
mapping, within the secure enclave, each client identity to a temporary session identifier using cryptographic operations;
mapping, within the secure enclave, each temporary session identifier to an ephemeral routing identifier;
mixing, within the secure enclave, destination requests from other clients into batched output traffic; and
forwarding, by the host process, packets of the batched output traffic to external network destinations, such that a source identity of each packet of the batched output traffic remains unlinkable to the external network destinations.

2. The method of claim 1, wherein the secure enclave comprises a hardware-isolated memory region that is encrypted at a central processor level, preventing unauthorized access by operating system or administrative processes.

3. The method of claim 2, further comprising verifying enclave integrity via a remote attestation, wherein the remote attestation guarantees that the secure enclave is genuine, unmodified, executing and secure.

4. The method of claim 3, wherein code of the secure enclave is compiled using a deterministic build process that produces a reproducible enclave measurement hash from a given set of source code, and wherein verifying the enclave integrity further comprises:
publishing the given set of source code of the secure enclave as a published source code;
a client device independently compiling the published source code using the deterministic build process to produce a locally-computed enclave measurement hash;
retrieving, by the client device, an enclave measurement hash from the remote attestation as a retrieved enclave measurement hash; and
comparing the locally-computed enclave measurement hash with the retrieved enclave measurement hash to verify that the secure enclave is executing the published source code without modification.

5. The method of claim 2, wherein the host process maintains a plurality of concurrent communication channels with the secure enclave, and wherein mixing the destination requests from the other clients further comprises:
receiving, by the secure enclave, an encrypted network request from a first client device via a first communication channel of the plurality of concurrent communication channels;
processing the encrypted network request within the secure enclave to produce a decrypted outbound packet; and
transmitting the decrypted outbound packet from the secure enclave to the host process via a second communication channel of the plurality of concurrent communication channels, the second communication channel being selected by a deterministic rotation across the plurality of concurrent communication channels, such that the host process cannot correlate the encrypted network request received on the first communication channel with the decrypted outbound packet transmitted on the second communication channel.

6. The method of claim 4, wherein the host process maintains a plurality of concurrent communication channels with the secure enclave, and wherein mixing the destination requests from the other clients further comprises:
receiving, by the secure enclave, an encrypted network request from a first client device via a first communication channel of the plurality of concurrent communication channels;
processing the encrypted network request within the secure enclave to produce a decrypted outbound packet; and
transmitting the decrypted outbound packet from the secure enclave to the host process via a second communication channel of the plurality of concurrent communication channels, the second communication channel being selected by a deterministic rotation across the plurality of concurrent communication channels, such that the host process cannot correlate the encrypted network request received on the first communication channel with the decrypted outbound packet transmitted on the second communication channel.

7. The method of claim 1, wherein the cryptographic operations in the secure enclave include at least one of encryption, authentication, key exchange, hashing, and identity blinding functions.

8. The method of claim 1, wherein traffic mixing comprises batching, padding, dummy traffic generation, and traffic shaping to prevent timing correlation and packet-size analysis.

9. A method for anonymizing network traffic within a hardware-isolated execution environment, the method comprising:
receiving, within a secure enclave, a decrypted network packet originating from a first client device of a plurality of client devices, the decrypted network packet bearing a source address that identifies the first client device;
mapping, by performing network address translation within the secure enclave by replacing the source address of the decrypted network packet with a shared masquerade address and assigning an ephemeral port number, and recording the mapping in a connection-tracking table stored in encrypted memory of the secure enclave, to produce a translated network packet;
forwarding the translated network packet from the secure enclave to a host process for transmission to an external network destination having a destination address, the host process receiving only the shared masquerade address as a source address of the translated network packet; and
upon receiving a return packet addressed to the shared masquerade address and the ephemeral port number, translating, within the secure enclave, the destination address back to the source address of the decrypted network packet using the connection-tracking table,
wherein the host process has no access to the connection-tracking table and cannot determine which of the plurality of client devices originated any given outbound packet.

10. The method of claim 9, wherein the host process maintains a plurality of concurrent communication channels with the secure enclave, and the method further comprises mixing one or more destination requests from the plurality of client devices comprising:
receiving, by the secure enclave, an encrypted network request from the first client device via a first communication channel of the plurality of concurrent communication channels;
processing the encrypted network request within the secure enclave to produce a decrypted outbound packet; and
transmitting the decrypted outbound packet from the secure enclave to the host process via a second communication channel of the plurality of concurrent communication channels, the second communication channel being selected by a deterministic rotation across the plurality of concurrent communication channels, such that the host process cannot correlate the encrypted network request received on the first communication channel with the decrypted outbound packet transmitted on the second communication channel.

11. A system for hardware-enforced anonymization of network traffic, the system comprising:
a host process managing encrypted network traffic with no access to correlation between user identities and network destinations; and
a secure enclave that is hardware isolated and configured to execute cryptographic mapping from the user identities to ephemeral route identifiers, and perform traffic mixing and anonymization.

12. The system of claim 11, wherein the secure enclave further comprises a network address translation engine executing entirely within a memory region that is hardware-isolated and encrypted, the network address translation engine configured to:
maintain, within the secure enclave, connection-tracking tables that map each of a plurality of network addresses of a plurality of client devices and port each of the plurality of network addresses to a shared masquerade address and an ephemeral port number selected by the secure enclave, the ephemeral port number corresponding to the shared masquerade address;
rewrite a source address of each outbound packet corresponding to each originating client device's network address to the shared masquerade address and the ephemeral port number, such that all outbound packets forwarded by the host process bear only the shared masquerade address as their source;
for each inbound return packet received by the host process, forward the corresponding inbound return packet to the secure enclave, which translates the shared masquerade address and the ephemeral port number back to the corresponding originating client device's network address using the connection-tracking tables; and
discard expired connection-tracking entries based on per-protocol timeouts, wherein the connection-tracking tables and all address-mapping state reside exclusively within the memory region of the secure enclave, and no process outside the secure enclave has access to any mapping between any client device's address and the shared masquerade address.

13. The system of claim 11, further comprising a remote attestation process, enabling each of a plurality of client devices to verify that the secure enclave is unmodified and operating within genuine hardware protections;
wherein the secure enclave is compiled using a deterministic build process such that identical source code produces an identical enclave measurement hash; and
wherein the remote attestation process further enables a client device of the plurality of client devices to independently compile the identical source code of the secure enclave, derive a locally-computed enclave measurement hash, and compare the locally-computed enclave measurement hash against the identical enclave measurement hash reported in the remote attestation process, thereby verifying that the secure enclave is executing an exact published source code.

14. The system of claim 12, further comprising a remote attestation process, enabling each of the plurality of client devices to verify that the secure enclave is unmodified and operating within genuine hardware protections;
wherein the secure enclave is compiled using a deterministic build process such that identical source code produces an identical enclave measurement hash; and
wherein the remote attestation process further enables a client device to independently compile the identical source code of the secure enclave, derive a locally-computed enclave measurement hash, and compare the locally-computed enclave measurement hash against the identical enclave measurement hash reported in the remote attestation process, thereby verifying that the secure enclave is executing an exact published source code.

15. The system of claim 11, further comprising a plurality of concurrent inter-process communication channels between the host process and the secure enclave, wherein the secure enclave is configured to:
receive inbound encrypted packets from a plurality of client devices via the plurality of communication channels;
after decrypting and processing each of the inbound encrypted packets within the secure enclave into a processed packet, select an outbound communication channel as a selected outbound communication channel from the plurality of communication channels using a rotating index that is independent of a communication channel of the plurality of communication channels on which a corresponding inbound encrypted packet of the inbound encrypted packets was received;
transmit the processed packet to the host process via the selected outbound communication channel; and
whereby the host process observes the inbound encrypted packets and outbound processed packets distributed across the plurality of communication channels without ability to correlate which inbound packet on a given channel corresponds to which outbound packet on another channel.

16. The system of claim 11, wherein the secure enclave is configured to store all identity-related mappings, ephemeral keys, and route identifiers in encrypted memory, inaccessible to any process outside the secure enclave.

17. The system of claim 11, wherein the secure enclave executes one or more cryptographic functions.

18. The system of claim 11, wherein no logs or records associating any of the user identities with destination addresses of the network destinations are stored outside the secure enclave, ensuring physical unavailability of correlation data.

19. The system of claim 11, further comprising a traffic obfuscation mechanism that injects dummy packets and padding to obscure real traffic patterns from observers.

20. The system of claim 12 further comprising a plurality of concurrent inter-process communication channels between the host process and the secure enclave, wherein the secure enclave is configured to:
receive inbound encrypted packets from client devices via the plurality of communication channels;
after decrypting and processing each of the inbound encrypted packets within the secure enclave into a processed packet, select an outbound communication channel as a selected outbound communication channel from the plurality of communication channels using a rotating index that is independent of a communication channel of the plurality of communication channels on which a corresponding inbound encrypted packet of the inbound encrypted packets was received;
transmit the processed packet to the host process via the selected outbound communication channel; and
whereby the host process observes the inbound encrypted packets and outbound processed packets distributed across the plurality of communication channels without ability to correlate which of the inbound encrypted packets on a given channel corresponds to which of the outbound processed packets on another channel.
